(19) United States
(12) Patent Application Publication
(10) Pub. No.: US 2007/0247557 A1
(43) Pub. Date: Oct. 25, 2007

(54) THIN FILM TRANSISTOR ARRAY PANEL AND LIQUID CRYSTAL DISPLAY

(76) Inventors: Yong-Suk YEO, Jecheon-si (KR); Won-Sang Park, Yongin-si (KR); Young-Bae Jung, Hwaseong-si (KR); Jae-Hyun Kim, Suwon-si (KR); Jae-Young Lee, Yongin-si (KR); Yong-Seok Cho, Seoul (KR); Seung-Kyu Lee, Suwon-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/738,326

(22) Filed: Apr. 20, 2007

(30) Foreign Application Priority Data
Apr. 21, 2006 (KR) 10-2006-0036233

(51) Int. Cl. G02F 1/136

(52) U.S. Cl. 349/43

(57) ABSTRACT

A thin film transistor (TFT) array panel exhibiting reduced residual images includes: an insulation substrate; gate lines formed on the insulation substrate; storage electrode lines formed between gate lines on the insulation substrate and including a plurality of storage electrodes; data lines crossing the gate lines and the storage electrode lines; TFTs each having first to third terminals, the first terminal being connected with the gate line and the second terminal being connected with the data line; and pixel electrodes connected with the third terminals of the TFTs and including upper, lower, left, and right sides. Each storage electrode line includes portions that overlap the upper, lower, left, and right sides of each pixel electrode and peripheral portions exposed out of each pixel electrode, each pixel electrode includes a plurality of sub electrodes and connections connecting the sub electrodes, and the plurality of sub electrodes, excluding the portion connected with the third terminal of the TFT, are symmetrical to each other. Because the storage electrode lines exposed near the pixel electrode are formed to be symmetrical up and down and left and right, the influence of a voltage of the storage electrode lines is symmetrically made on liquid crystals.

### CROSS-REFERENCE TO RELATED APPLICATION

This application claims priority to and the benefit of Korean Patent Application No. 10-2006-0036233 filed in the Korean Intellectual Property Office on Apr. 21, 2006, the entire contents of which are incorporated herein by reference.

### BACKGROUND OF THE INVENTION

1. Field of the Invention

The present invention relates to a thin film transistor (TFT) array panel and a liquid crystal display (LCD) having the TFT array panel.

2. Description of the Related Art

A liquid crystal display (LCD) includes two display panels on which field generating electrodes such as pixel electrodes and a common electrode are formed, and a liquid crystal layer interposed therebetween. A voltage is applied to the field generating electrodes to generate an electric field that determines the alignment of the liquid crystal molecules and controls the polarization of incident light, thereby allowing images to be displayed.

The LCD includes field generating electrodes, thin film transistors (TFTs) connected to the field generating electrodes, a plurality of pixels arranged in a matrix form, and a plurality of signal lines for transferring signals to the pixels. The signal lines include gate lines for transferring scan signals and data lines for transferring data signals, and each pixel includes a color filter for displaying color as well as the field generating electrode and the TFT.

The gate lines, the data lines, pixel electrodes and the TFTs are arranged on one of two display panels called a TFT array panel. Another display panel generally includes common electrodes and color filters and is generally called a common electrode panel.

The pixel electrodes face the common electrodes and generate an electric field when the LCD is driven. The generated electric field determines the alignment of the liquid crystal molecules of the liquid crystal layer. The related art m-PVA has a certain cut-out pattern at the pixel electrodes and the common electrodes, and includes pixel electrodes including one or more sub electrodes. In such a structure, the gate lines and the data lines surrounding the pixel electrodes have a symmetrical structure, and storage electrodes overlap the pixel electrodes in an asymmetrical structure.

A storage electrode may include one portion that overlaps a pixel electrode and another portion that does not overlap the pixel electrode. When an LCD is driven, the exposed portions of the storage electrodes that asymmetrically overlap the pixel electrodes change the electric field, aligningaligning the liquid crystal molecules of the liquid crystal layer in an arbitrary direction causing the liquid crystals to collide with each other to generate an instantaneous residual image that adversely affectsaffects display quality.

### SUMMARY OF THE INVENTION

According to one aspect of thethe present invention a thin film transistor (TFT) array panel minimizes the instantaneous residual image arising from collision of the liquid crystals by preventing storage electrodes from being exposed where they asymmetrically overlap pixel electrodes.

An exemplary embodiment of the present invention provides a TFT array panel including: an insulation substrate; gate lines formed on the insulation substrate; storage electrode lines formed between gate lines on the insulation substrate and including a plurality of storage electrodes; data lines crossing the gate lines and the storage electrode lines; TFTs, each of the TFTs having first to third terminals, the first terminal being connected with the gate line and the second terminal being connected with the data line; and pixel electrodes connected with the third terminals of the TFTs and including upper, lower, left, and right sides. Each of the storage electrode lines include portions that overlap the upper, lower, left, and right sides and peripheral portions exposed out of each pixel electrode. Each of the pixel electrodes include a plurality of sub electrodes and connections connecting the sub electrodes, and the plurality of sub electrodes, excluding the portion connected with the third terminal of the TFT, are symmetrical to each other.

The upper and lower sides of the pixel electrode can be the upper and lower sides of one of the plurality of sub electrodes, and the lower side of the pixel electrode may include a protrusion connected with the third terminal of the TFT.

The storage electrode may include first to fourth portions that overlap the upper, lower, left, and right sides of the pixel electrode, and the first to fourth portions can be connected to form a closed curved line.

the peripheral portions of the storage electrode lines have a symmetrical structure centering on the pixel electrode

Another embodiment of the present invention provides a liquid crystal display (LCD) device including: a first insulation substrate; gate lines formed on the first insulation substrate; storage electrode lines formed between gate lines on the first insulation substrate and including a plurality of storage electrodes; data lines formed on the first insulation substrate and crossing the gate lines and the storage electrode lines; TFTs, each of the TFTs having first to third terminals, the first terminal being connected with the gate line and the second terminal being connected with the data line; pixel electrodes connected with the third terminals of the TFTs and including a plurality of sub electrodes and connections connecting the sub electrodes; a second insulation substrate facing the first insulation substrate; common electrodes formed on the second insulation substrate; inclination direction determining members formed on the common electrodes; and a liquid crystal layer interposed between the first and second insulation substrates. The storage electrode line comprises a portion that overlaps an upper side of the uppermost one of the sub electrodes and is exposed to the periphery of the uppermost sub electrode and a portion that overlaps the lower side of the lowermost one of the sub electrodes and is exposed to the periphery of the lowermost sub electrode.

The pixel electrode may include the plurality of sub electrodes and the connections connecting the sub electrodes, and the plurality of sub electrodes, excluding the portion connected with the third terminal of the TFT, are symmetrical to each other.

Each of the organic protrusion may be formed at a position corresponding to the center of each sub electrode.

The inclination direction determining member includes cutouts formed in the common electrode or organic protrusions formed on the common electrode.

Each sub electrode may have a rectangular shape with rounded corners.

### BRIEF DESCRIPTION OF THE DRAWINGS

FIG. 1 is a layout view of a liquid crystal display (LCD) device including a thin film transistor (TFT) array panel and a common electrode panel according to an exemplary embodiment of the present invention.

FIG. 2 is a layout view of the common electrode panel of the LCD in FIG. 1.

FIG. 3 is a layout view of the TFT array panel of the LCD in FIG. 1.

FIGS. 4 and 5 are cross-sectional views taken along lines IV-IV″ and V-V′, respectively, of the LCD including the TFT array panel and the common electrode panel in FIG. 1.

FIG. 6 is a layout view of a TFT of FIG. 3 in an intermediate stage in its fabrication according to the exemplary embodiment of the present invention.

FIGS. 7 and 8 are cross-sectional views taken along lines VII-VII′ and VIII-VIII′ of the TFT array panel in FIG. 6, respectively.

FIG. 9 is a layout view of the TFT panel in the next stage of FIG. 6.

FIGS. 10 and 11 are cross-sectional views taken along lines X-X′ and XI-XI′ of the TFT array panel in FIG. 8, respectively.

FIG. 12 is a layout view of the TFT array panel in the next stage in FIG. 9.

FIGS. 13 and 14 are cross-sectional views taken along lines XIII-XIII′ and XIV-XIV′ of the TFT array panel in FIG. 12, respectively.

### DETAILED DESCRIPTION OF THE EMBODIMENTS

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

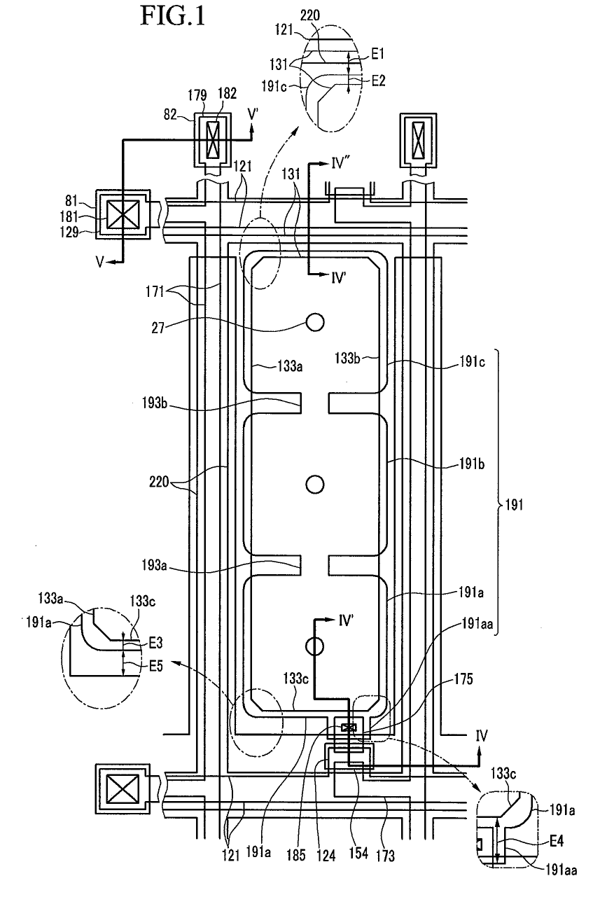

A liquid crystal display (LCD) according to the exemplary embodiment of the present invention will now be described with reference to FIGS. 1 to 5.

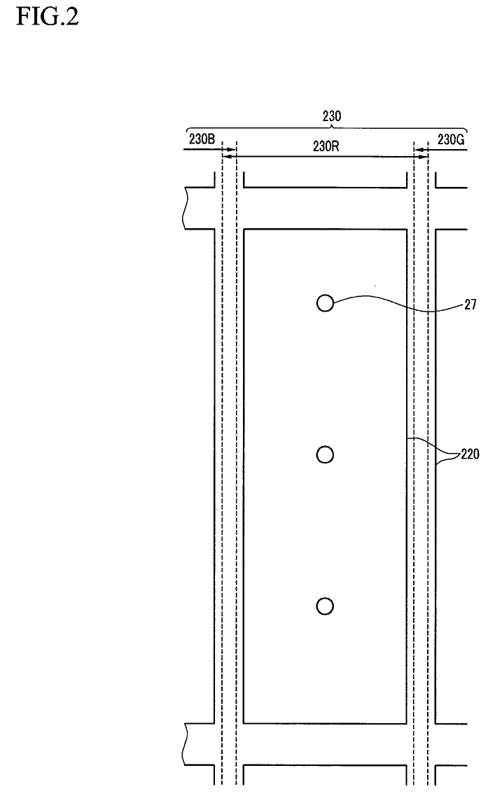

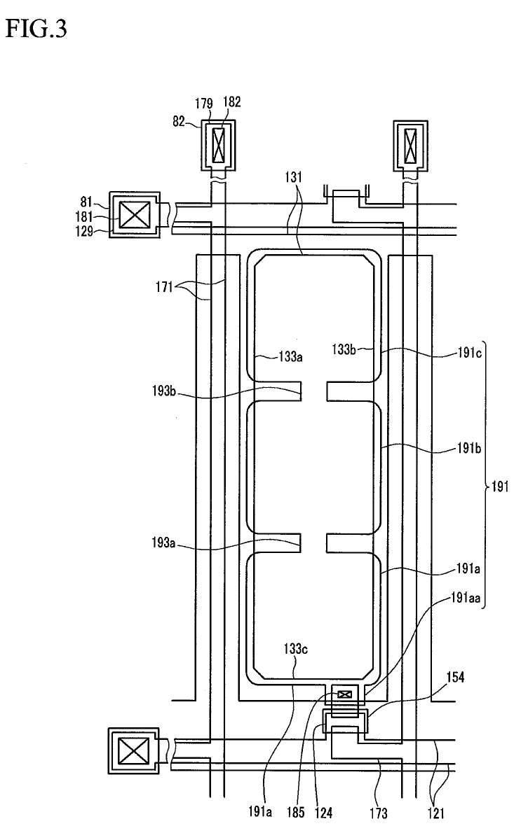

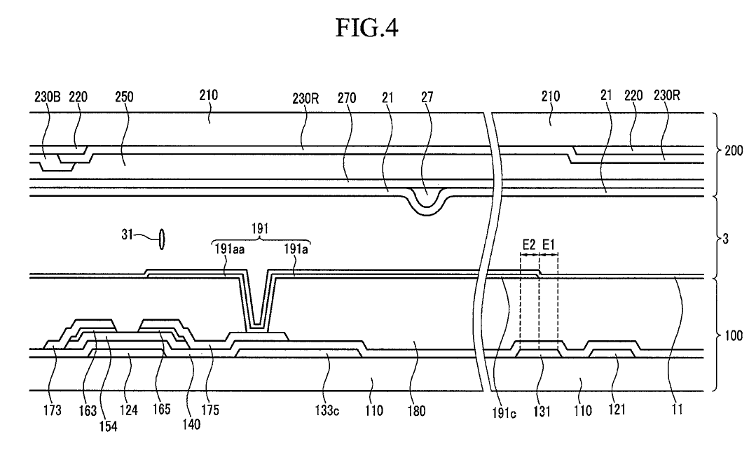

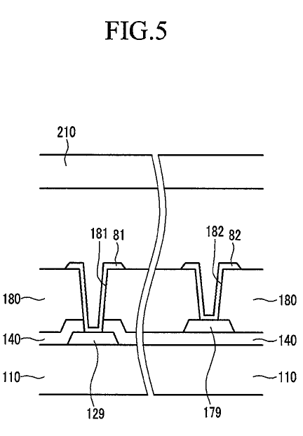

FIG. 1 is a layout view of a liquid crystal display (LCD) device including a thin film transistor (TFT) array panel and a common electrode panel according to an exemplary embodiment of the present invention, FIG. 2 is a layout view of the common electrode panel of the LCD in FIG. 1, FIG. 3 is a layout view of the TFT array panel of the LCD in FIG. 1, and FIGS. 4 and 5 are cross-sectional views taken along lines IV-IV″ and V-V′, respectively, of the LCD including the TFT array panel and the common electrode panel in FIG. 1.

With reference to FIGS. 1 to 5, the LCD according to the exemplary embodiment of the present invention includes a TFT array panel 100 and a common electrode panel 200 that face each other, and a liquid crystal layer 3 interposed between the two display panels 100 and 200.

First, the TFT array panel 100 will be described as follows.

With reference to FIGS. 1, 3, 4, and 5, a plurality of gate lines 121 and a plurality of storage electrode lines 131 are formed on an insulation substrate 1made of transparent glass or plastic.

The gate lines 121 transfer gate signals and extend mainly in a horizontal direction.

The gate lines 121 include a plurality of gate electrodes 124 that are protruded upward and a large end portion 129 for a connection with a different layer or an external driving circuit. A gate driving circuit (not shown) for generating gate signals can be mounted on a flexible printed circuit film (not shown) attached on the insulation substrate 110, directly mounted on the insulation substrate 110, or integrated with the insulation substrate 110. When the gate driving circuit is integrated with the insulation substrate 110, the gate lines 121 can be elongated to be directly connected thereto.

The storage electrode lines 131 receive a predetermined voltage and include a branch line extending substantially parallel to the gate lines 121 and pairs of storage electrodes 133a and 133b and connections 133c. Each storage electrode line 131 is positioned between two adjacent gate lines 121, and the branch line is closer to the upper one of the two gate lines 121. The area of the connection 133c parallel to the branch line is larger than that of the branch line. The connection 133c connects the storage electrodes 133a and 133b that are present within one pixel. The storage electrode line 131 can be modified in various shapes and dispositions according to the structure of the pixel electrode of a single pixel.

The gate lines 121 and the storage electrode lines 131 can be made of an aluminum-based metal such as aluminum (A) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), titanium (Ti), etc. Also, the gate lines 121 and the storage electrode lines 131 can have a multi-layered structure including two conductive layers (not shown) each having different physical properties. One of the conductive layers can be made of a metal with low resistivity, such as the aluminum-based metal, the silver-based metal, or the copper-based metal, etc. in order to reduce a signal delay or a voltage drop. The other conductive layer can be made of a material such as the molybdenum-based metal, chromium, tantalum, titanium, etc., that has good physical, chemical, and electrical contact characteristics with a different material, particularly ITO (indium tin oxide) and IZO (indium zinc oxide). Good examples of such combination may include a combination of a lower chromium layer and an upper aluminum (alloy) layer, and a combination of a lower aluminum (alloy) layer and an upper molybdenum (alloy) layer. In addition, the gate lines 121 and the storage electrode lines 131 can be made of various other metals or conductors.

The sides of the gate lines 121 and the storage electrode lines 131 are sloped to the surface of the insulation substrate 110, and preferably the slope angle is within the range of about 30° to 80°.

A gate insulating layer 140 made of silicon nitride (SiNx) or silicon oxide (SiOx), etc., is formed on the gate lines 121 and the storage electrode lines 131.

A plurality of semiconductor islands 154 made of hydrogenated amorphous silicon (a−Si) or polycrystalline silicon, etc., are formed on the gate insulating layer 140. Each semiconductor island 1 54 is positioned at an upper side of a gate electrode 124.

A plurality of ohmic contacts 163 and 165 are formed on the semiconductor island 154. The ohmic contacts 163 and 165 can be made of a material such as n+ hydrogenated amorphous silicon in which an n-type impurity such as phosphor is doped with a high density, or silicide. The ohmic contacts 163 and 165 are disposed as pairs on the intrinsic semiconductor island 154.

The side of the intrinsic semiconductor island 154 and the side of ohmic contacts 163 and 165 are also sloped to the surface of the insulation substrate 110, and the slope angle is within the range of 30° to 80°.

A plurality of data lines 171 and a plurality of drain electrodes 175 are formed on the ohmic contacts 163 and 165, and the gate insulating layer 140.

The data lines 171 transfer data signals and extend mainly in a vertical direction to cross the gate lines 121. Each data line 171 includes a plurality of source electrodes 173 extending toward the gate electrode 124 and a large end portion 179 for a connection with a different layer or an external driving circuit. A data driving circuit (not shown) can be mounted on a flexible printed circuit film (not shown) attached on the insulation substrate 110, directly mounted on the insulation substrate 110, or integrated with the insulation substrate 110. When the data driving circuit is integrated with the substrate 110, the data line 171 can be elongated to be connected thereto.

The drain electrode 175 is separated from the data line 171 and faces the source electrode 173 centering on the gate electrode 124.

One gate electrode 124, one source electrode 173, and one drain electrode 175 constitute a thin film transistor (TFT) together with the semiconductor island 154, and a channel of the TFT is formed at the semiconductor island 154 between the source electrode 173 and the drain electrode 175.

Preferably, the data line 171 and the drain electrode 175 are made of a refractory metal such as molybdenum, chromium, tantalum, titanium, etc., or their alloys, and can have a multi-layered structure including the refractory metal layer (not shown) and a low-resistance conductive layer (not shown). Examples of the multi-layered structure may include a dual-layer of a lower chromium or molybdenum (alloy) layer and an upper aluminum (alloy) layer, and a triple-layer of a lower molybdenum (alloy) layer, an intermediate aluminum (alloy) layer, and an upper molybdenum (alloy) layer. Also, the data line 171 and the drain electrode 175 can be made of various other metals or conductors.

Preferably, the side of the data line 171 and the side of the drain electrode 175 are also sloped to the surface of the substrate 110 at a slope angle within the range of about 30° to 80°.

The ohmic contacts 163 and 165 exist only between the lower semiconductor island 154 and the upper data line 171 and the drain electrode 175, in order to lower contact resistance therebetween. Some portions of the semiconductor island 154 including a portion between the source electrode 173 and the drain electrode 175 are exposed without being covered by the data line 171 and the drain electrode 175.

A passivation layer 180 is formed on the data line 171 and the drain electrode 175, and on the exposed portion of the semiconductor island 154.

The passivation layer 180 is made of an inorganic insulator or an organic insulator, etc., and may have a planarized surface. The inorganic insulator can be, for example, silicon nitride or silicon oxide. The organic insulator may have photosensitivity, and its dielectric constant is preferably 4.0 or less. In this respect, the passivation layer 180 may have a dual-layered structure of a lower inorganic layer and an upper organic layer so that it may not do harm to the exposed portion of the semiconductor island 154 while still sustaining the excellent insulation characteristics of the organic layer.

At the passivation layer 180, there are formed a plurality of contact holes 182 and 185 exposing the end portions 179 of the data lines 171, and the drain electrodes 175, and at the passivation layer 180 and the gate insulating layer 140, there are formed a plurality of contact holes 181 exposing the end portions 129 of the gate lines 121.

A plurality of pixel electrodes 191 and a plurality of contact assistants 81 and 82 are formed on the passivation layer 180.

Each pixel electrode 191 includes first to third sub electrodes 191a, 191b, and 191c that have a rectangular shape with rounded corners and are arranged in a row. The first sub electrode 191a includes an electrode protrusion 191aa and is connected with the drain electrode 175 via the contact hole 185. The first and second sub electrodes 191a and 191b are connected by a first connection member 193a, and the second and third sub electrodes 191b and 191c are connected by a second connection member 193b. Herein, the first and second connection members 193a and 193b are disposed at each center of the mutually adjacent sides of the first to third sub electrodes 191a, 191b, and 191c.

The pixel electrode 191 receives a data voltage from the drain electrode 175 connected with the first sub electrode 191a, and the data voltage is also applied to the second and third sub electrodes 191b and 191c through the first and second connection members 193a and 193b. The pixel electrode 191, to which the data voltage has been applied, generates an electric field together with the common electrode 270 of the common electrode panel 200 that receives a common voltage, to thereby determine the direction of the liquid crystal molecules 31 of the liquid crystal layer 3 therebetween. The electric field is affected by the storage electrode line 131 that has an exposed portion overlapping the edby pixel electrode 191. When the storage electrode lines 131 exposed at the periphery of the pixel electrode 191 are asymmetrical, the influence of the voltage of the storage electrode lines 131 becomes asymmetrical and changes the alignment of the liquid crystals resulting in different texture appearing in the image. Namely, if the disposition of the storage electrode lines 131 exposed at the periphery of the pixel electrode 191 is asymmetrical, the texture also appears asymmetrically. When a gray level voltage is changed, a longer time is needed for the liquid crystals to be balanced and the texture appearing on an image after reaching the balanced state becomes non-uniform thereby generating an instantaneous residual image that adversely affects display quality.

Thus, in the present exemplary embodiment, in order to prevent generation of the instantaneous residual image and improve the display quality, the storage electrode lines 131 exposed at the periphery of the image display region of the pixel electrode 191 are disposed as symmetrically as possible.

In the exemplary embodiment of the present invention, the storage electrode lines 131 exposed at the periphery of the pixel electrode 191 are formed to be symmetrical up and down and left and right. For a connection with the drain electrode 175, the protrusion 191 aa of the pixel electrode 191 cannot have the symmetrical form due to the protruded structure.

As shown in FIG. 4, the portion E1 of storage electrode line 131 is exposed beyond the outside edge of the upper side of the third sub electrode 191c of the pixel electrode 191. The connection 133c of the storage electrode line 131 is exposed to the outer side of the lower side of first sub electrode 191a of the pixel electrode 191 at a portion (E5), and storage electrodes 133a and 133b are disposed at the left and right sides of the pixel electrode 191.

The polarization of light transmitted through liquid crystal layer 3 differs depending on the direction of the liquid crystal molecules as determined by the electric field between the pixel electrodes 191 of the TFT array panel 100 and the common electrode 270 of the common electrode panel 200. The pixel electrode 191 and the common electrode 270 form a capacitor (referred to hereinafter as “liquid crystal capacitor”) to sustain the applied voltage even after the TFT is turned off.

The contact assistants 81 and 82 are connected with the end portion 129 of the gate line 121 and the end portion 179 of the data line 171 via the contact holes 181 and 182. The contact assistants 81 and 82 increase the adhesion of the end portion 129 of the gate line 121 and the end portion 179 of the data line 171 with an external device.

The common electrode panel 200 will now be described.

With reference to FIGS. 1, 2, 4, and 5, a light blocking member 220 is formed on the insulation substrate 210 made of transparent glass or plastic. The light blocking member 220 is also called a black matrix, it defines a plurality of opening regions facing the pixel electrodes 191, and it prevents light leakage between pixel electrodes 191.

A plurality of color filters 230 including color filters 230R, 230G, and 230B are formed on the substrate 210, which are disposed to be within the opening regions surrounded by the light blocking member 200. The color filters 230 can be elongated in a vertical direction along the pixel electrodes 191 to form a stripe. Each color filter 230R, 230G, and 230B can display one of the three primary colors of red (R), green (G), and blue (B). Edges of neighboring color filters 230 can overlap with each other.

An overcoat 250 is formed on the color filters 230 and the light blocking members 220. The overcoat 250 can be made of an (organic) insulator, and it protects the color filters 230, prevents the color filters 230 from being exposed, and provides a planarized surface.

The common electrode 270 is formed on the overcoat 250. Preferably, the common electrode 270 is made of a transparent conductor such as ITO or IZO.

A plurality of organic protrusions 27 are formed on the common electrodes 270, and each protrusion 27 is disposed at a position corresponding to the center of the first to third sub electrodes 191a to 191c.

The protrusions 27 may be replaced with cutouts (not shown) formed in the common electrodes 270.

Alignment layers 11 and 21 are coated on an inner surface of the display panels 100 and 200, and they can be vertical alignment layers. Polarizers (not shown) are provided on an outer surface of the display panels 100 and 200, and the polarization axes of the two polarizers are perpendicular to each other.

In the present exemplary embodiment, the LCD may further include a phase retardation film (not shown) for compensating delay of the liquid crystal layer 3. The LCD may further include a backlight unit (not shown) for providing light to the polarizers, the phase retardation film, the display panels 100 and 200, and the liquid crystal layer 3.

The liquid crystal layer 3 has negative dielectric anisotropy, and liquid crystal molecules 31 of the liquid crystal layer 3 are aligned such that their longer axes are substantially perpendicular to the surfaces of the two display panels 100 and 200 in a state that there is no electric field. Accordingly, incident light is blocked, rather than passing through the crossed polarizers.

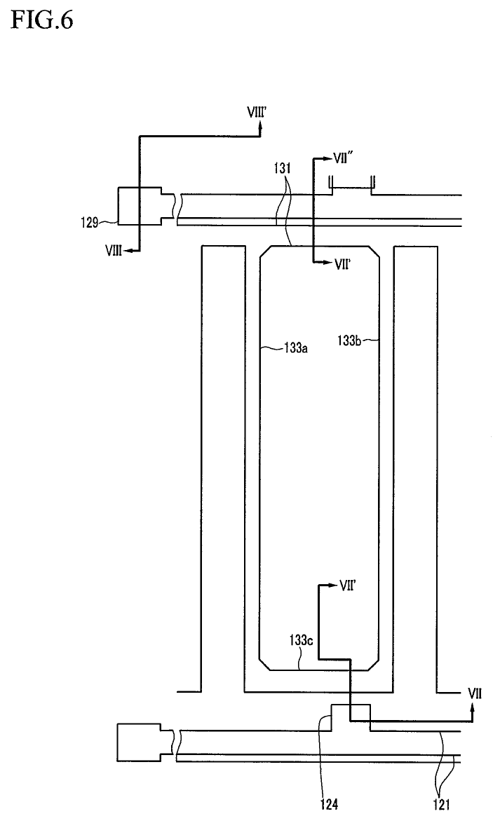

The method for fabricating the TFT array panel of the LCD as described above will now be explained in detail with reference to FIGS. 6 to 13.

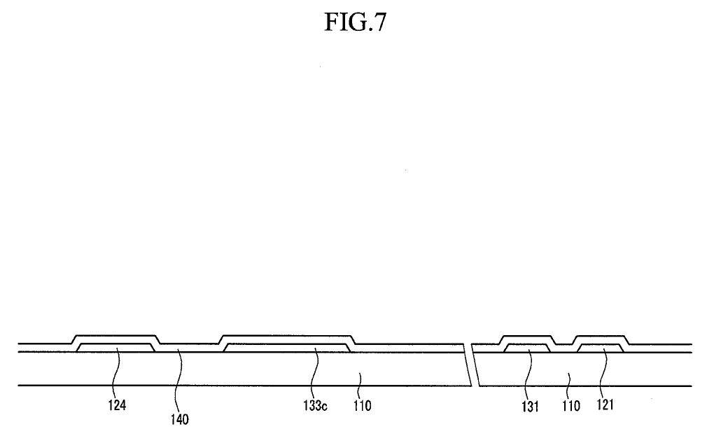

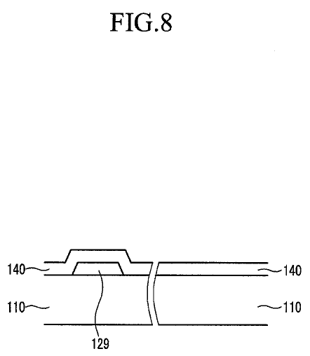

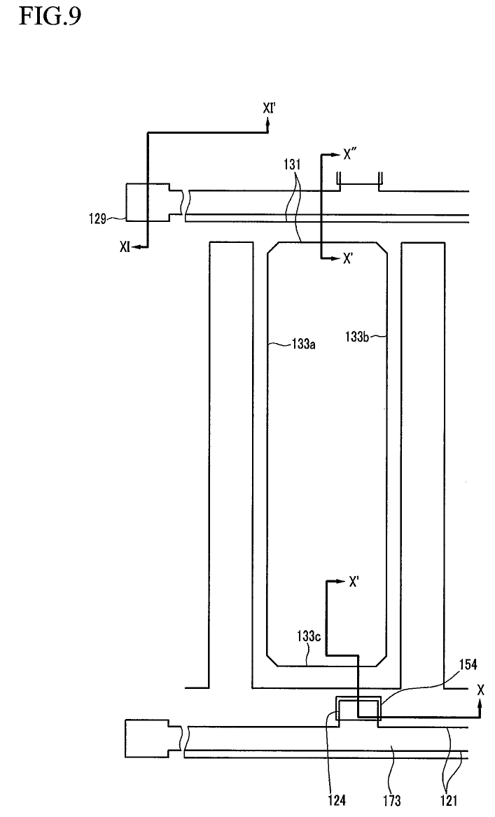

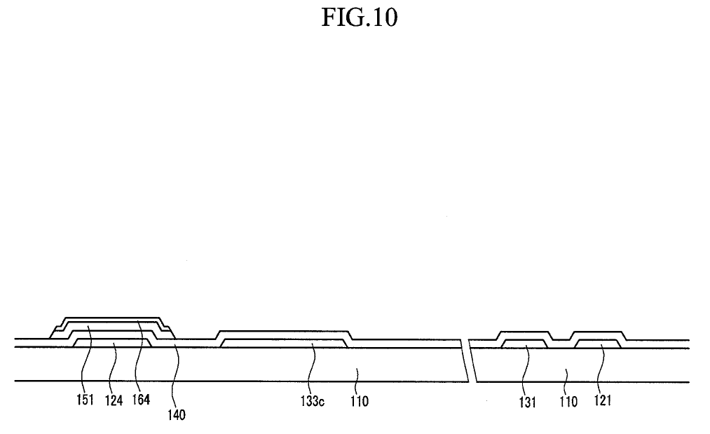

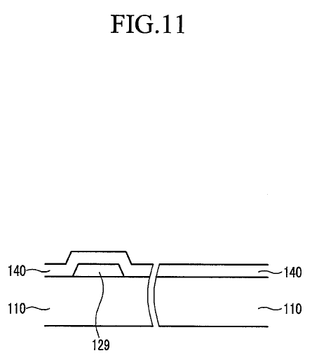

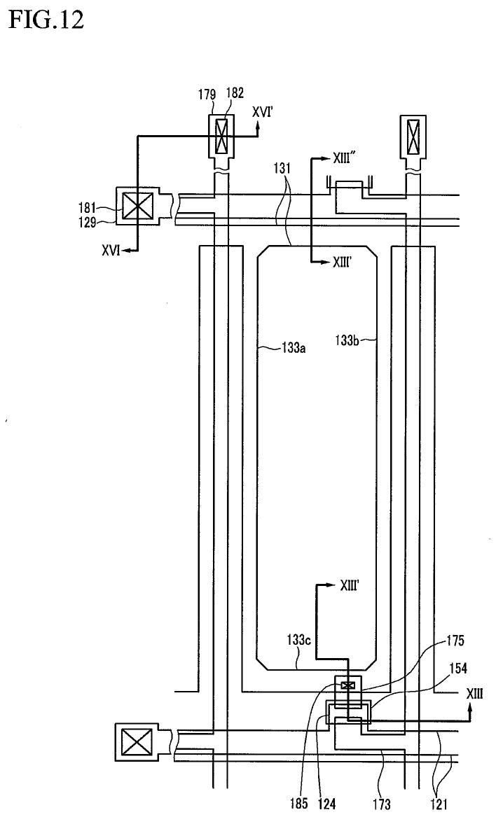

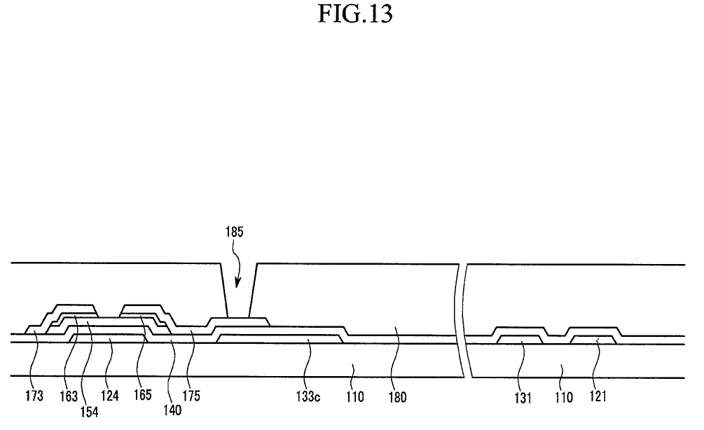

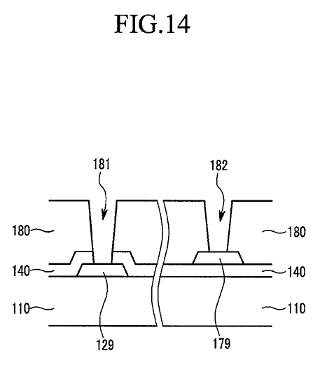

FIG. 6 is a layout view of a TFT of FIG. 3 in an intermediate stage in its fabrication according to the exemplary embodiment of the present invention, FIGS. 7 and 8 are cross-sectional views taken along lines VII-VII′ and VIII-VIII′ of the TFT array panel in FIG. 6, respectively, FIG. 9 is a layout view of the TFT panel in the next stage of FIG. 6, FIGS. 10 and 11 are cross-sectional views taken along lines X-X′ and XI-XI′ of the TFT array panel in FIG. 8, respectively, FIG. 12 is a layout view of the TFT array panel in the next stage in FIG. 9, and FIGS. 13 and 14 are cross-sectional views taken along lines XIII-XIII′ and XIV-XIV′ of the TFT array panel in FIG. 12, respectively.

First, as shown in FIGS. 6 to 8, a metal layer is stacked on the insulation substrate 110 made of transparent glass or the like through sputtering. Then, the resulting structure is etched through photolithography to form the plurality of gate lines 121 including the gate electrode 124 and the end portion 129, and the storage electrode lines 131 including the storage electrodes 133a and 133b and the connections 133c connecting the storage electrodes 133a and 133b.

Next, the gate insulating layer 140 made of silicon nitride (SiNx) is deposited on the gate lines 121 and the storage electrode lines 131.

Thereafter, as shown in FIGS. 9 to 11, intrinsic amorphous silicon (a−Si) in which an impurity has not been doped and amorphous silicon (n+a−Si) in which an impurity has been doped are deposited on the gate insulating layer 140 through plasma enhanced chemical vapor deposition (PECVD). The impurity-doped amorphous silicon and the intrinsic amorphous silicon are etched through photolithography to form an intrinsic semiconductor island 154 and an impurity semiconductor layer 164.

Then, as shown in FIGS. 12 and 14, a metal layer such as aluminum is stacked on the impurity semiconductor layer 164 and the gate insulating layer 1 40 through sputtering and then etched to form the source electrode 173 and the drain electrode 175 including the end portion 179.

Subsequently, a portion of the impurity semiconductor layer 164 that is exposed without being covered by the source electrode 173 and the drain electrode 175 is removed to complete the ohmic contacts 163 and 165 and expose the intrinsic semiconductor island 154 below the ohmic contacts 163 and 165. In this case, oxygen (O₂) plasma bombardment is performed on the surface of the exposed the intrinsic semiconductor island 154 to stabilize it.

Then, the passivation layer 180 is formed with an organic material or an inorganic material with good planarization characteristics and photosensitivity, on which a photosensitive film is coated, light is irradiated thereto through an optical mask, which is then developed to form a plurality of contact holes 181, 182, and 185.

As shown in FIGS. 3 and 4, the transparent conductive layer such as ITO or IZO is then stacked on the passivation layer 180 through sputtering and then patterned to form the pixel electrode including the first to third sub electrodes 191a, 191b, and 191c and the first and second connection members 193a and 193b, and the contact assistants 81 and 82.

The first connection member 193a is disposed at the center of the mutually adjacent sides of the first and second sub electrodes 191a and 191b, and the second connection member 193b is disposed at the center of the mutually adjacent sides of the second and third sub electrodes 191b and 191 c.

In the pixel electrode 191 having such a structure, the first sub electrode 191a (with the rounded corners like the second and third sub electrodes 191b and 191c), additionally includes the electrode protrusion 191 aa and is connected with the drain electrode 175 via the contact hole 185.

One side of the third sub electrode 191c close to the upper gate line 121 overlaps (El) the storage electrode line 131, and the side of the first sub electrode 191a is disposed to be close to the lower gate line 121 and symmetrical to the side of the third sub electrode 191c overlapping the storage electrode line 131 and the protrusion 191aa extending from the side of the first sub electrode overlap (E3 and E4) with the connection 133c of the storage electrode line 131. Besides the portions E2, E3, and E4 that overlap the edge of pixel electrode 191, the storage electrode line 131 and the connection 133c have exposed portions E1 and E5. The storage electrode line 131 forms a single closed curved line as the storage electrodes 133a and 133b, the connection 133c.

In this manner, in the present invention, the storage electrode line 131 and the exposed portion of the connection 133c have an almost symmetrical structure centering on the pixel electrode 191, unlike the related art in which the exposed portion of the storage electrode line overlapping the pixel electrode has an asymmetrical structure.

As described above, in the exemplary embodiment of the present invention, because the storage electrode lines exposed near the pixel electrode are formed to be symmetrical up and down and left and right, the storage electrode lines symmetrically influence the electric field applied to liquid crystals. Accordingly, liquid crystals are symmetrically aligned in the display regions of the pixels, and thus the instantaneous residual image is reduced and the display quality is enhanced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A thin film transistor (TFT) array panel comprising:
an insulation substrate;
gate lines formed on the insulation substrate;
storage electrode lines formed between the gate lines on the insulation substrate and comprising a plurality of storage electrodes;
data lines crossing the gate lines and the storage electrode lines;
TFTs, each of the TFTs having first to third terminals, the first terminal being connected with the gate line and the second terminal being connected with the data line; and
pixel electrodes connected with the third terminals of the TFTs and each comprising upper, lower, left, and right sides,
wherein each of the storage electrode lines comprise portions that overlap the upper, lower, left, and right sides and peripheral portions exposed out of each pixel electrode, and each of the pixel electrodes comprise a plurality of sub electrodes and connections connecting the sub electrodes, and the plurality of sub electrodes, excluding a portion connected with the third terminal of the TFT, are symmetrical to each other.

2. The array panel of claim 1, wherein the upper and lower sides of the pixel electrode are upper and lower sides of one of the plurality of sub electrodes, and the lower side of the pixel electrode comprises a protrusion connected with the third terminal of the TFT.

3. The array panel of claim 2, wherein the storage electrode comprises first to fourth portions that overlap with the upper, lower, left, and right sides of the pixel electrode, and the first to fourth portions are connected to form a closed curved line.

4. The array panel of claim 1, wherein the peripheral portions have a symmetrical structure centering on the pixel electrode

5. A liquid crystal display (LCD) device comprising:
a first insulation substrate;
gate lines formed on the first insulation substrate;
storage electrode lines formed between the gate lines on the first insulation substrate and comprising a plurality of storage electrodes;
data lines formed on the first insulation substrate and crossing the gate lines and the storage electrode lines;
TFTs, each of the TFTs having first to third terminals, the first terminal being connected with the gate line and the second terminal being connected with the data line;
pixel electrodes connected with the third terminals of the TFTs and each of the pixel electrodes comprising a plurality of sub electrodes and connections connecting the sub electrodes;
a second insulation substrate facing the first insulation substrate;
common electrodes formed on the second insulation substrate;
inclination direction determining members formed on the common electrodes; and
a liquid crystal layer interposed between the first and second substrates,
wherein each of the storage electrode lines comprise a portion that overlaps an upper side of the uppermost one of the sub electrodes and is exposed at the periphery of the uppermost sub electrode and a portion that overlaps the lower side of the lowermost one of the sub electrodes and is exposed to the periphery of the lowermost sub electrode.

6. The liquid crystal display (LCD) device of claim 4, wherein each pixel electrode comprises a plurality of sub electrodes and the connections connecting the sub electrodes, and the plurality of sub electrodes, excluding the portion connected with the third terminal of the TFT, are symmetrical to each other.

7. The liquid crystal display (LCD) device of claim 55, wherein the inclination direction determining member includes cutouts formed in the common electrode field generation electrode or a organic protrusions formed on the common electrode field generation electrode.

8. The liquid crystal display (LCD) device of claim 7, wherein each of the organic protrusions are formed at a position corresponding to the center of each sub electrode.

9. The liquid crystal display (LCD) device of claim 8, wherein each of the sub electrodes have a rectangular shape with rounded corners.
